(19) United States
(12) Patent Application Publication
(10) Pub. No.: US 2005/0123653 A1
(43) Pub. Date: Jun. 9, 2005

(54) Cooked meat product and method of preparing same

(76) Inventor: Claude Rollier, Paris (FR)

Correspondence Address: STURM & FIX LLP, 206 SIXTH AVENUE, SUITE 1213, DES MOINES, IA, 50309-4076, US

(21) Appl. No.: 11/032,394

(22) Filed: Jan. 10, 2005

(30) Foreign Application Priority Data
Sep. 17, 1999 (FR) 99 11680

(51) Int. Cl. A23L 1/31

(52) U.S. Cl. 426/92

(57) ABSTRACT

The invention relates to a salt-treated cooked pork or poultry product which is free of preservatives in the form of nitrates or nitrites and to a process for making the same.

### TECHNICAL FIELD OF THE INVENTION

The present invention relates to a salt-treated, cooked pork or poultry product, characterized in that it is free of preservatives in the form of nitrates or nitrites.

It also relates to a method for preparing these products.

### BACKGROUND OF THE ART

The salt-treated, cooked pork and poultry products intended by the present invention are chosen from the group comprising especially pork leg and shoulder, poultry legs, particularly turkey and chicken legs, and cooked roasts from pork, turkey and turkey poult.

The cooked pork and poultry products according to the present invention are salt-treated in such a way that the conventional pickling solution is replaced with a solution containing a food-grade alcohol, table salt and, optionally, other ingredients which may form part of the pickling brine, such as sugars, flavorings, antioxidants, etc., but contain no preservatives in the form of nitrates or nitrites.

Within the context of the present patent application, the term “preservative” is understood to mean any substance which extends the preservation life of foodstuffs by protecting them from degradation due to microorganisms. This definition is taken from the Code of Uses of Cold-Meats, 1997 Edition, page 2, 359.

The assignee is already the proprietor of a European patent application, filed on May 28, 1999 under the number 98/401278, which describes a method for preparing meat products using a pickling step.

This method is characterized in that the pickling brine is substituted, in part or in its entirety, with food-grade alcohol. It allows meat products to be obtained which have improved organoleptic qualities, while maintaining their coloration, their preservation properties and their cutability.

However, this patent application specifies that the brine, or pickling solution, consists of water to which nitrited salt, antioxidants, preservatives, sugars and flavorings have been added.

The method described in that patent application always results in products containing nitrites, since the pickling solution contains nitrites, even if the water itself is replaced with a food-grade alcohol.

The use of nitric acid salts as preservatives for meat has been known for a very long time. The addition of potassium nitrate, known by the name saltpeter, to meat is extremely ancient. In point of fact, documents reveal that it was commonly used in the Middle Ages.

The nitrate is reduced to nitrite under the action of nitrate reductases produced by microbes naturally present in meat.

The antibacterial effect of the nitrites is beneficial because of the fact that it is exerted on a large number of bacterial germs. Above all, the nitrites inhibit the growth of bacillus botulinus—a very common microbe which produces a fatal toxin.

However, nitrites present both direct and indirect toxicity.

With regard to their-direct toxicity, they convert human myoglobin and hemoglobin into metmyoglobin and methemoglobin, thus inhibiting their ability to transport oxygen through the body.

As regards their indirect toxicity, they may react with amines, coming from the degradation of proteins, to form nitrosamines. Nitrosamines are toxic, carcinogenic and mutagenic.

Thus, the use of nitrates/nitrites in meat products, especially by including them in the pickling solution, suffers from a major drawback, namely the toxicity of these products.

### DESCRIPTION OF THE INVENTION

However, the assignee has, surprisingly and unexpectedly, discovered through the extensive work and research which it has carried out on the preparation of salt-treated meat products, that it is possible to obtain a salt-treated product entirely satisfactorily from the standpoint of its preservation by essentially replacing the pickling solution with a mixture of table salt and a food-grade alcohol, without any nitrate-based or nitrite-based preservative being present, which preservative is normally present in a conventional pickling solution.

Bacterial control in the products according to the invention is in fact provided by the presence of alcohol fixed in the flesh of the salt-treated, cooked pork or poultry product. The product is preserved after vacuum cooking in a bag without it being necessary to use nitrates or nitrites. It follows that there is no risk of toxic by-products, of the type described above, developing in the product.

The salt-treated, cooked pork or poultry products according to the invention are free of any preservative in the form or nitrates or nitrites and therefore represent real progress in terms of food safety for consumers.

The food-grade alcohol is chosen from the group containing wines and spirits, and mixtures thereof.

The amount of alcohol contained in the products depends on that used in the pickling solution. It is detectable by the methods well known to those skilled in the art for the chemical analysis and detection of ethyl alcohol.

Of course, the product according to the invention may also contain other ingredients usually present in a conventional pickling solution, such as sugars, flavorings, antioxidants, etc.

The sugars are chosen from the group comprising especially glucose, saccharose and dextrins, or mixtures thereof.

The flavorings are chosen according to the final taste that a person skilled in the art wishes to give the cooked pork or poultry product.

The antioxidants are chosen from the group comprising food-grade antioxidants and especially ascorbic acid or salts thereof.

Other food-grade products used in pickling brines may also be added to the pickling solution, such as especially texture stabilizers, such as gums, and flavor-fixing agents, such as glutamates, or mixtures thereof.

The method of preparing a salt-treated, cooked pork or poultry product according to the invention is characterized in that, during the pickling step, the pickling solution is replaced with a solution consisting of a food-grade alcohol, table salt and, optionally, other ingredients which may form part of a conventional pickling solution, but without the addition of preservatives in the form of nitrates or nitrites.

According to a preferred way of implementing the invention, the method consists in carrying out the following steps:
cutting and deboning the pieces of meat;
injecting under pressure a pickling solution containing a food-grade alcohol, table salt and, optionally, other ingredients such as sugars and flavorings, but containing no preservative in the form or nitrates or nitrites;
continuing the impregnation of the pieces of meat with the pickling solution by mixing in a vacuum churn;
forming the pieces of meat in vacuum bags;
cooking; and
cooling.

The invention also relates to a pickling solution for butchery and charcuterie products, characterized in that it contains a food-grade alcohol, table salt and, optionally, other ingredients such as sugars and flavorings and in that it is free of any preservative in the form of nitrates or nitrites.

A better understanding of the invention will be gained from the examples which follow, these being given purely by way of illustration.

### EXAMPLE 1

### Preparation of a Pickling Solution According to the Invention

A pickling solution was prepared by mixing the following ingredients:

| | |
|---|---|
| 11° white wine | 30 kg |
| SPH | 0.3 kg |
| Bouquet 400 | 2.4 kg |
| Glutonic V10 | 4.8 kg |
| ascorbic acid | 0.315 kg |
| table salt | 4.5 kg. |

SPH is a sodium polyphosphate, Bouquet 400 is a mixture of flavorings and Glutonic V10 is a mixture of dextrose and table salt. These products are all sold by Jeager.

### EXAMPLE 2

### Preparation of Cooked Pork Leg with the Aid of the Pickling Solution Prepared in Example 1

A pork leg was cut and deboned. Next, the pickling solution prepared in Example 1 was injected under pressure directly into the deboned leg, using hollow needles, in an amount of 15 kg of pickling brine per 100 kg of meat. Impregnation with the pickling brine was continued in a rotary vacuum churn at a temperature of between 4 and 6° C. for 14 to 18 hours.

The churn was drained and the leg pieces put into plastic bags, and then into a mold to form them.

The pieces of meat were put under a vacuum and then cooked in a wet steam oven with the temperature rising in stages, so as to reach a core temperature of 65° C. The total cooking time was between 14 and 18 hours.

Next, the leg pieces were removed from the oven and placed for 24 hours in a rapid cooling room in which the temperature was set to between 2 and 4° C.

They were then stored in a refrigerated room at a temperature of between 2 and 4° C.

A cooked leg was thus obtained which had the taste of white wine and had long preservation qualities resulting from it being stabilized with respect to bacterial germs.

1-19. (canceled)

20. A method for preparing long preservation salt-treated, cooked pork or poultry products free of nitrates or nitrites, including:
cutting and deboning the pork or poultry products,
injecting under pressure a pickling solution containing a food-grade alcohol, table salt but containing no preservative in the form or nitrates or nitrites,
continuing the impregnation of the pork or poultry products with the pickling solution by mixing in a vacuum churn;
forming the pork or poultry products in vacuum bags;
cooking during 14-18 hours at a temperature ensuring a core temperature of the meat of 65° C.; and
cooling.

21. The method according to claim 20, wherein the cooked pork or poultry products are selected from the group consisting of pork leg and shoulder, poultry legs, turkey and chicken legs, cooked roasts from pork, turkey and turkey poult.

22. The method according to claim 20, wherein the pickling solution further contains other ingredients selected from the group consisting of sugars and flavorings.

23. The method according to claim 20, wherein the meat product is selected from the group consisting of pork leg and shoulder, poultry legs and cooked roast from pork.

24. The method according to claim 20, wherein the alcohol is selected from the group consisting of wines and spirits, and mixtures thereof.

25. The method according to claim 20, wherein the product is selected from the group consisting of turkey and chicken legs.

26. The method according to claim 20, wherein the product is selected from the group consisting of turkey and turkey poult.
